(19) United States
(12) Patent Application Publication
(10) Pub. No.: US 2006/0180664 A1
(43) Pub. Date: Aug. 17, 2006

(54) Wirelessly deliverable and redeemable secure couponing system and method

(76) Inventors: Patrick V. Barrett, San Francisco, CA (US); William Luoma, San Francisco, CA (US)

Correspondence Address: CHARLES LOUIS THOEMING, 1390 WILLOW PASS ROAD, SUITE 1020, CONCORD, CA, 94520, US

(21) Appl. No.: 11/108,123

(22) Filed: Apr. 15, 2005

Related U.S. Application Data
(60) Provisional application No. 60/653,436, filed on Feb. 15, 2005.

(51) Int. Cl. G06K 15/00; G07G 1/14

(52) U.S. Cl. 235/383; 705/14

(57) ABSTRACT

A secure wireless supplemental content delivery method and system based upon a Java 2 Platform Micro Edition application. The system and method provide a one-time user application suitable for all wireless environments, including binary run-time environments or wireless application protocol where image saving is not possible, without reliance upon mobile base stations. Content comprising coupons does not require barcodes or other special point-of-sale infrastructure changes for redemption.

### CROSS-REFERENCES TO RELATED APPLICATIONS

This United States non-provisional patent application is based upon and claim the filing date of U.S. provisional patent application Ser. No. 60/653,436, filed 15 Feb. 2005.

### STATEMENT REGARDING FEDERALLY SPONSORED RESEARCH OR DEVELOPMENT

None.

### REFERENCE TO A MICRO-FICHE APPENDIX

None.

### REFERENCE TO SEQUENCE LISTING ON CD-ROM

The source code and example programs of an embodiment of the present invention are provided on CD-ROM disks marked Copy 1 and Copy 2 in conformity with 37 C.F.R. § 1.52.

### NOTICE REGARDING COPYRIGHTED MATERIAL

A portion of the disclosure of this patent document contains material which is subject to copyright protection. The copyright owner has no objection to the facsimile reproduction by anyone of the patent document or the patent disclosure as it appears in the file or records as maintained by the United States Patent and Trademark Office, but otherwise reserves all copyright rights whatsoever.

### TECHNICAL FIELD

The embodiments of the present invention described herein related generally to the field of wireless coupon delivery over General Packet Radio Service (“GPRS”) and other wireless technologies. Specifically the invention relates to a method and system for secure and unique wireless coupon distribution and redemption comprising Java 2 Platform Micro Edition (“J2ME”) software and other platform execution environments available on mobile handsets. The coupon delivery method and system of the present invention is provided over any type of network without: (1) additional carrier support; (2) user proximity to a retail location; or (3) mandatory use of barcodes.

### BACKGROUND OF THE INVENTION

A search of the prior art located the following United States patents which are believed to be representative of the present state of the prior art: U.S. Patent Pub. No. 2003/0212762 A1, published Nov. 13, 2003; U.S. Patent Pub. No. 2004/0260608 A1, published Dec. 23, 2004; U.S. Patent Pub. No. 2004/0117255 A1, published Jun. 17, 2004; U.S. Patent Pub. No. 2002/0128908 A1, published Sep. 12, 2002; U.S. Patent Pub. No. 2004/0260605 A1, published Dec. 23, 2004; U.S. Patent Pub. No. 2004/0203963 A1, published Oct. 13, 2004; U.S. Pat. No. 6,685,093 B2, issued Feb. 3, 2004; International Patent No. WO/2004/056026 A2, published Jul. 1, 2004; and U.S. Pat. No. 6,775,539 B2, issued Aug. 10, 2004.

### DISCLOSURE OF INVENTION

The present invention relates to providing secure, wireless coupon distribution and redemption using receiving devices that accept Java 2 Platform Micro Edition (“J2ME”) (.jar) files. A user may receive a coupon, or similar marketing promotion, from a retailer based upon existing systems or methods that use Short Message System (“SMS”) or barcode graphics. However, for a variety of reasons, the coupon promotion may be frustrated by limitations of current systems and methods. There may be lack of security based upon the user's handset and the coupon application that permits transfer of the coupon between handset using Bluetooth, Multi-media Messaging Systems (MMS”) or SMS technologies. The system may require extensive support from a telecommunications carrier to successfully run the promotion based on heavy reliance on a mobile base station. Or, the system may rely on the use of barcodes for redemption or uniqueness, requiring barcode scanning equipment and the necessary steps to redeem using such hardware.

There is a present need for a secure wireless couponing method and system deliverable over any type of network.

There is further need for a secure wireless couponing method and system without extensive support from a telecommunications carrier.

Still further need exists for a secure wireless coupon system and method that does not require barcodes for redemption.

An embodiment of the present system and method enable retrieval of SMS messages containing a Uniform Resource Locator (“URL”) to the coupon application. The URL is appended with a unique code number that is recorded in the system database. The unique code recorded in the database is associated with a user receiving the SMS message and URL coding.

The present invention further includes a method incorporating the functions of the described system. Other features, advantages, and objects of the present invention will become apparent with reference to the following detailed description and accompanying figures.

### BRIEF DESCRIPTION OF DRAWINGS

FIG. 1 illustrates a one-time user requested wirelessly deliverable and redeemable secure coupon system and method according to an embodiment of the present invention where confirmed redemption is desired but not required.

FIG. 2 illustrates a one-time user requested wirelessly deliverable and redeemable secure coupon system and method according to an embodiment of the present invention where confirmed redemption is required without point-of-sale information collection capability.

FIG. 3 illustrates a one-time user requested wirelessly deliverable and redeemable secure coupon system and method according to an embodiment of the present invention where confirmed redemption is required with point-of-sale information collection capability.

FIG. 4 illustrates a one-time retailer pushed wirelessly deliverable and redeemable secure coupon system and method according to an embodiment of the present invention where confirmed redemption is desired but not required.

FIG. 5 illustrates a wirelessly deliverable and redeemable secure discount offer portal using a coupon system and method according to an embodiment of the present invention.

FIG. 6 illustrates a flowchart depicting steps in executing a secure coupon delivery application on a mobile handset within a wireless data communications network according to an embodiment of the present invention.

FIG. 7 illustrates a flowchart depicting steps in executing a secure coupon redemption application on a mobile handset within a wireless data communications network according to an embodiment of the present invention.

FIG. 8 illustrates a typical graphical user interface window depicting a wireless coupon offer and link to Java application descriptor according to an embodiment of the present invention.

FIG. 9 illustrates a flowchart depicting steps in executing a secure coupon redemption application on a mobile handset within a wireless data communications network with associated graphical user interface windows according to an embodiment of the present invention.

FIG. 10 illustrates a typical graphical user interface window depicting a wireless coupon offer and notice of offer expiration according to an embodiment of the present invention.

FIG. 11 illustrates a typical graphical user interface window depicting redemption status for a wireless coupon offer and instructions for the user to delete the coupon.

FIG. 12 illustrates delivery of secure wireless coupon according to an embodiment of the present invention.

### BEST MODE FOR CARRYING OUT THE INVENTION

94 pages detailing the source code files on CD-ROM, Copies 1 and 2, are provided to this specification. The source code should be consulted to provide details of a specific embodiment of the invention in conjunction with the discussion of the routines in this specification. The source code in CD-ROM, copies 1 and 2, includes Java 2 Platform Micro Edition (“J2ME”) source code along with modifications to the source code to implement the present invention; however, the present invention is platform independent and could be practiced using Binary Run-Time Environment for Wireless (“BREW”) or Wireless Application Protocol (“WAP”).

The present invention relates to a method, system and software to provide secure, wireless supplemental content and/or redemption using receiving devices that accept computer readable program code. In an embodiment of the present invention, the program code is written in Java 2 Platform Micro Edition (“J2ME”) (.jar) files, and provides secure, wireless coupon distribution and redemption using receiving devices that accept computer readable program code. The system and method of an embodiment of the present invention enable retrieval of a variety of SMS messages, each containing a Uniform Resource Locator (“URL”) to J2ME application. The URL is appended with a unique code number that is recorded in the system database. The unique code recorded in the database is associated with a user receiving the SMS message and URL coding. Other embodiments of the present invention provide supplemental content comprising cell phone wall paper and ring tones.

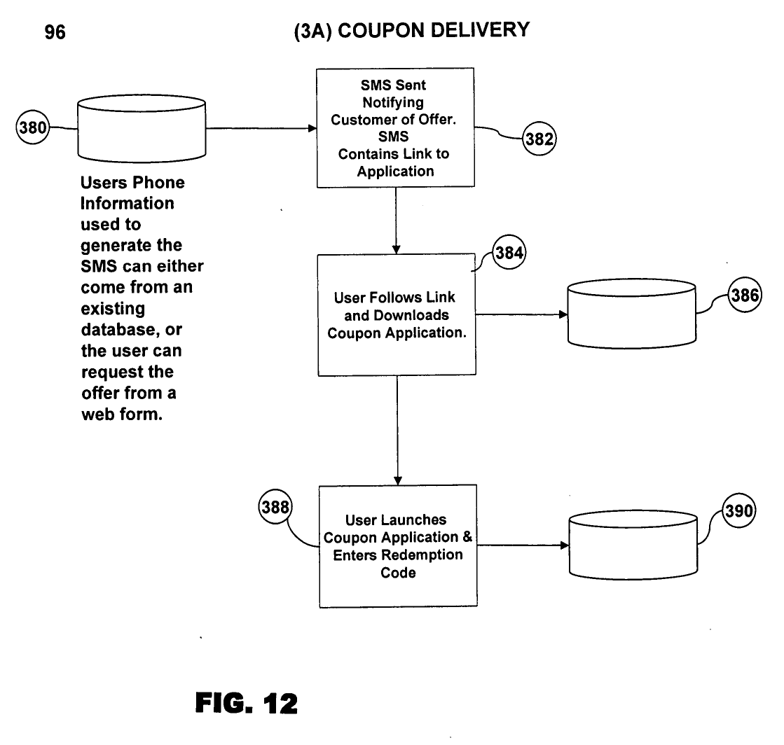

The architecture for the system of wireless coupon delivery 96 of an embodiment of the present invention is depicted in FIG. 12. As illustrated in FIG. 12, an embodiment of the present invention encompasses methods and systems for a consumer registering with a retailer database or receiving delivering and redeeming a secure and unique on-demand application for coupon to an end user on a data communications network. In step 380, unique user telephone data is used to generate the SMS. The information can either be generated from an existing database or can be provided by the user on a specific offer using a web format.

In step 382, the SMS is sent notifying the consumer of the coupon offer and providing the consumer with a link to the application.

In step 384, the consumer follows the link and downloads the coupon application.

In step 386, the notification identifier, password, and coupon identifier security parameters are verified within the database. Then the Java application descriptor file landing date and time and/or wireless application protocol profile are verified within the database. If the Java application descriptor file is received by the consumer handset in good state, a second access to the server by the handset is launched for the Java archive file. The server re-checks the security parameters and chronologically stores the Java archive file and appends a landing date and time.

In step 388, the user launches the coupon application and enters the unique coupon redemption code.

In step 390, the application accesses the database to lookup and verify the notification identification, password, coupon identification and redemption code security parameters. Once these security parameters are verified, the redemption code, point-of-sale identification, and redemption date and time are stored within the database.

In a preferred embodiment of the present invention, the data communications network is the Internet and display of the retailer's offers occurs over the World Wide Web. User interaction is provided into WAP or equivalent wireless networks.

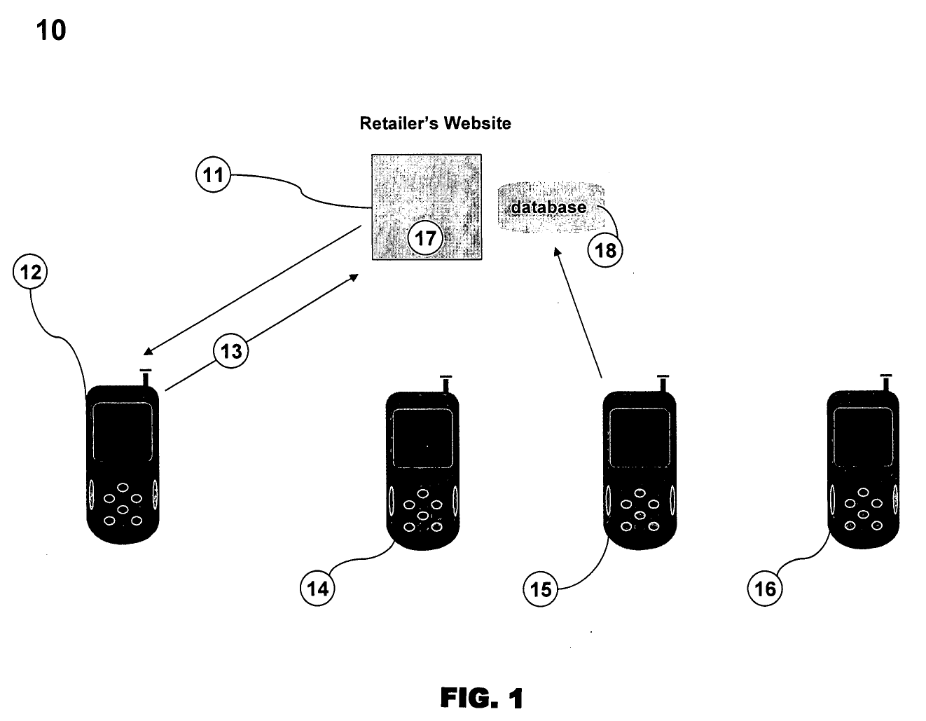

FIG. 1 depicts an embodiment of the present invention for a one time user-requested coupon 10 wherein confirmed redemption is desired but not required. In FIG. 1, a customer enters their phone number and their carrier identification 11 on a retailer's Website offer page, 17. An SMS message with a link to the mCoup™ is sent to the handset, 12. The customer follows the link and downloads a time-sensitive mCoup™ J2ME application on their mobile telephone handset, 13. At the point of sale, the customer activates the mCoup™ J2ME application and presents it to the cashier, 14. The point-of-sale cashier instructs the customer to enter a unique redemption code in the customer's mobile telephone and selects either the send or transmit key, 14. The customer's mobile telephone addresses the retailer's network database 18, attempting to connect to redeem the individual offer, 15. Regardless whether the mobile telephone connects with the server or not, the J2ME application sets the coupon to redeemed mode, 16. If the J2ME application was unable to connect to the network, the application continues attempting to connect each time it is subsequently launched until the coupon redemption is recorded in the retailer's network database, 18.

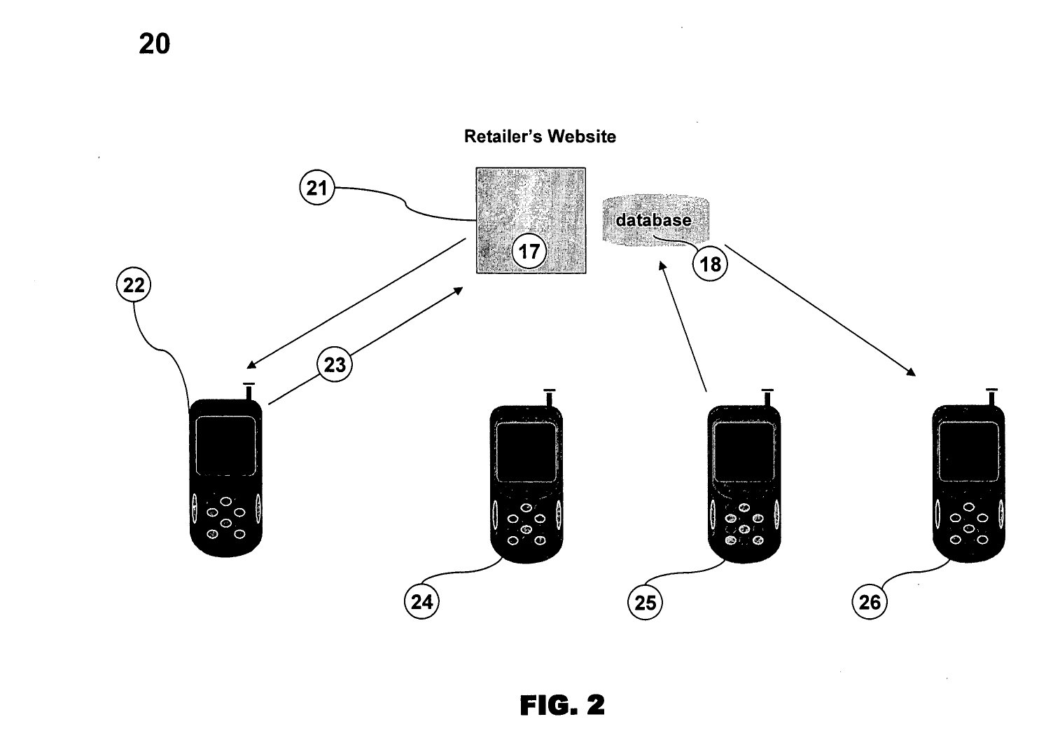

In another embodiment of the present invention 20 confirmed redemption is required, FIG. 2. In FIG. 2, as in the embodiment 10 illustrated in FIG. 1, a customer enters their phone number and their carrier identification 21 on a retailer's Website offer page, 17. An SMS message with a link to the mCoup™ is sent to the handset, 22. The customer follows the link and downloads a time-sensitive mCoup™ J2ME application on their mobile telephone handset, 23. At the point of sale, the customer activates the mCoup™ J2ME application and presents it to the cashier, 24. The point-of-sale cashier instructs the customer to enter a unique redemption code in the customer's mobile telephone and selects either the send or transmit key, 24. The customer's mobile telephone addresses the retailer's network database 18, attempting to connect to redeem the individual offer, 25. If the application is able to connect to the database 18, the coupon is redeemed 26. In the embodiment depicted in FIG. 2, however, there is no information collection capability at the point of sale. If the J2ME application was unable to connect to the network the offer is rejected by the retailer, 26.

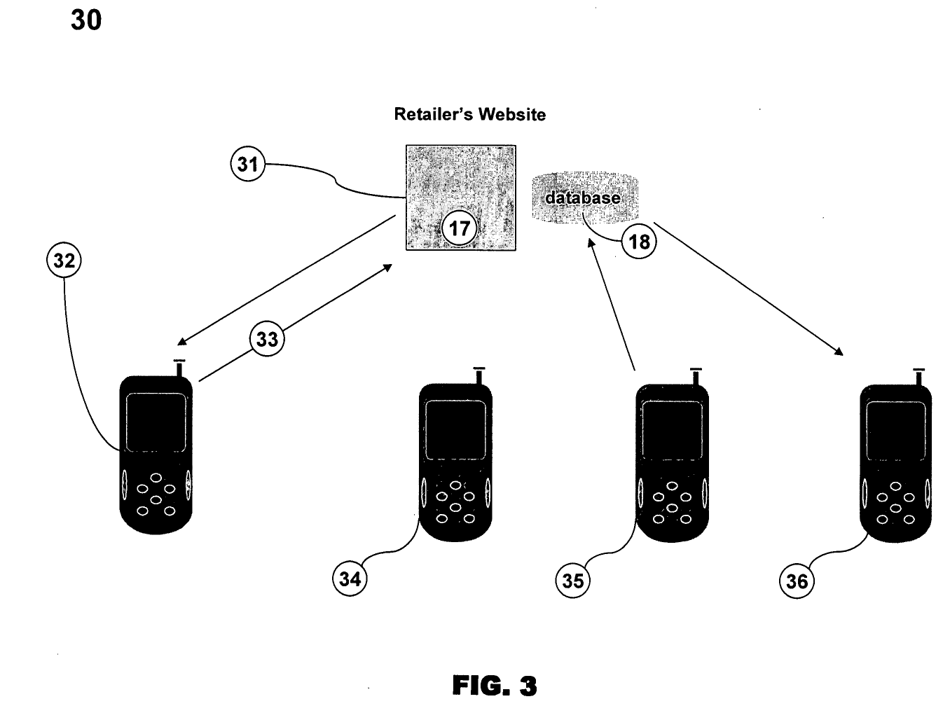

In yet another embodiment of the present invention confirmed redemption is required and information collection capability exists at the point of sale 30, as illustrated in FIG. 3. In FIG. 3, as in the embodiment 10 illustrated in FIG. 1 or the embodiment 20 illustrated in FIG. 2, a customer enters their phone number and their carrier identification 31 on a retailer's Website offer page, 17. An SMS message with a link to the mCoup™ is sent to the handset, 32. The customer follows the link and downloads a time-sensitive mCoup™ J2ME application on their mobile telephone handset, 33. At the point of sale, the customer activates the mCoup™ J2ME application and presents it to the cashier, 34. The point-of-sale cashier instructs the customer to enter a unique redemption code in the customer's mobile telephone and selects either the send or transmit key, 34. The customer's mobile telephone addresses the retailer's network database 18, attempting to connect to redeem the individual offer, 35. The J2ME application generates a unique code locally that the retailer can record to indicate that particular offer has been redeemed, 36. Alternatively, the application could display a pre-rendered barcode graphic packaged with the application at time of download that can be scanned at the point of sale. The associated J2ME application continues attempting to connect to the network point of sale, and continues to do so each time the application is launched until redemption is recorded, 36.

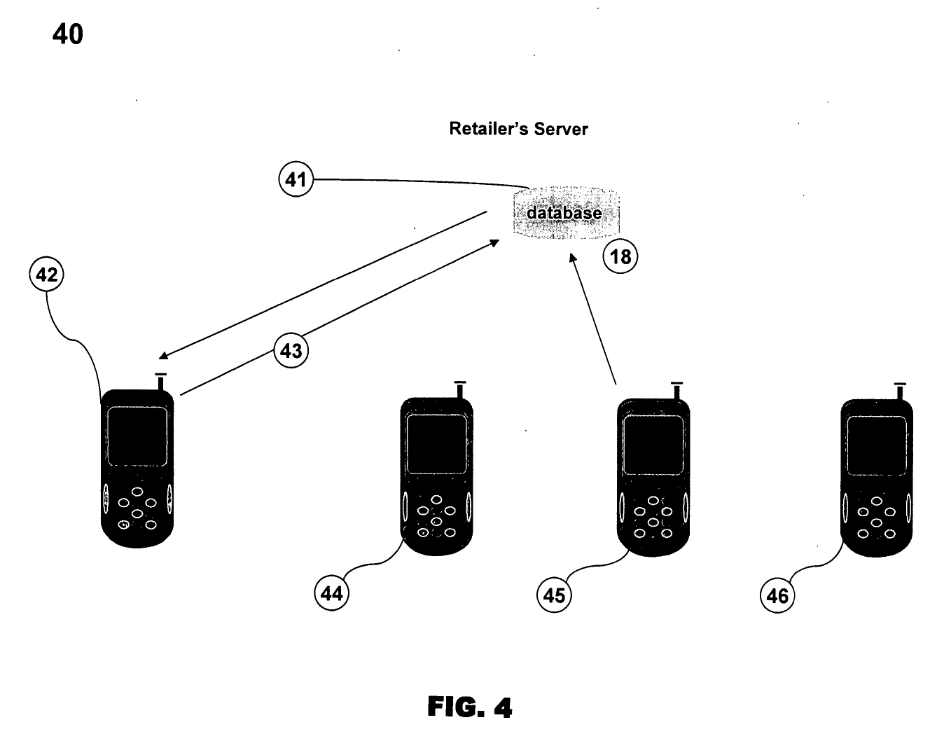

As depicted in FIG. 4, one time retailer coupons may be sent to consumers using a SMS mailing list according to an embodiment of the present invention 40. Using a SMS mailing list, a retailer sends at least one offer to consumers 41. An SMS message with a link to the mCoup™ is sent to the handset, 42. The customer follows the link and downloads a time-sensitive mCoup™ J2ME application on their mobile telephone handset, 43. The point-of-sale cashier instructs the customer to enter a unique redemption code in the customer's mobile telephone and selects either the send or transmit key, 44. The customer's mobile telephone addresses the retailer's network database 18, attempting to connect to redeem the individual offer, 45. Customer interaction and redemption scenarios 46 are identical to the varying options provided in the embodiments of the present invention illustrated in FIGS. 1-3.

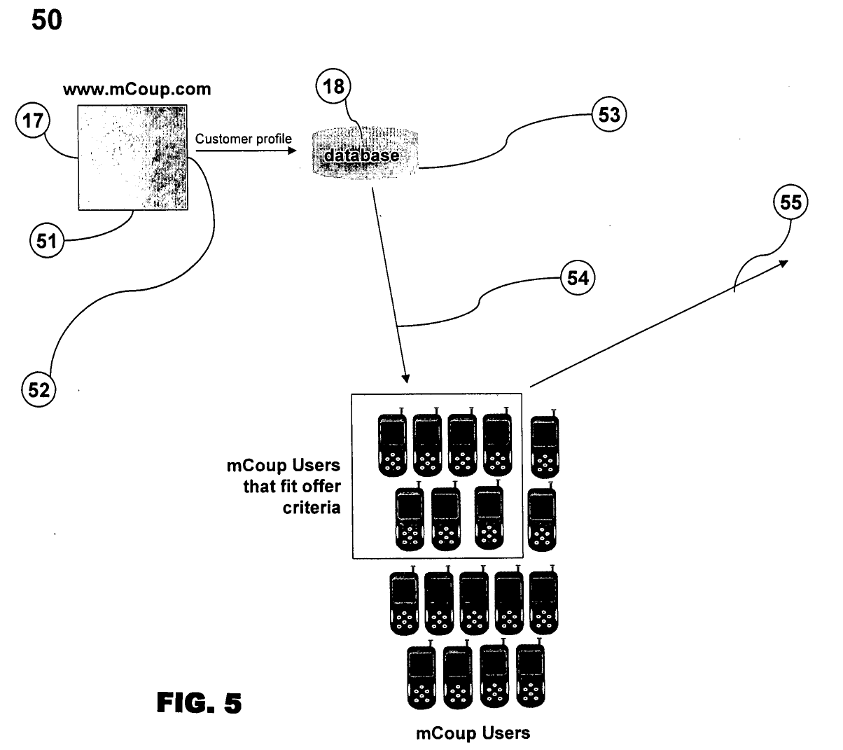

As illustrated in FIG. 5, the mCoup™ wireless discount offer portal 50 is presented by an embodiment of the present invention whereby a plurality of consumers register with mCoup™ by completing a questionnaire which provides the consumer's mobile telephone number and demographic information, 51. Retailers wishing to send targeted, time-sensitive incentive offers subscribe to the mCoup™ service, 52. A participating retailer then arranges with mCoup™ to send a particular offer to a subset of mCoup™ users meeting the retailer's target criteria, 53. The coupon delivery 54 and redemption 55 processes are the same as the embodiments for one time coupon delivery/redemption illustrated in FIGS. 1-4.

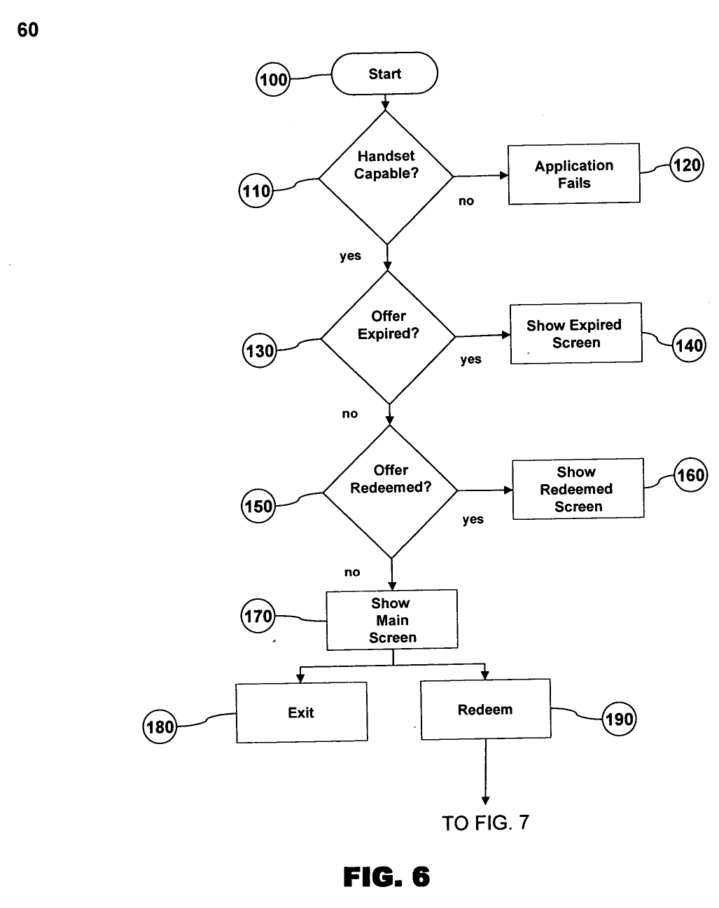

FIG. 6 illustrates the process 60 for running a secure wireless coupon application capable of supporting the embodiments of the present invention generally described above and illustrated in FIGS. 1-5.

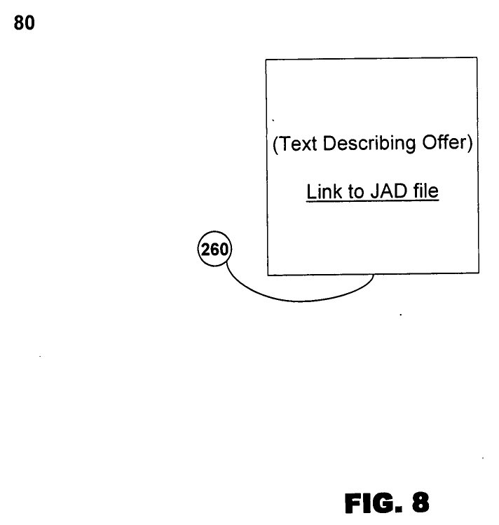

Initially, at step 100 the consumer accesses the system by registering with a retailer using the retailer's website, a toll free access telephone number, or similar telecommunications or Internet means. A registered customer in a select geographic region meeting minimum handset requirements receives a SMS message notifying them of an offer, as generally illustrated in FIG. 8. The SMS message contains an URL to a J2ME application. The URL is appended with a unique code number that is recorded in a database. The retailer can either send automatic offer notifications based on information in the retailer's respective database, or it can direct a customer to a self-service web-site where the customer can request a coupon for a particular offer.

If the consumer's handset is capable of accepting J2ME files, step 110, a user interface screen displays the offer and a link to the application, FIG. 8. Handsets incapable of accepting J2ME files fail to be included in the system, step 120.

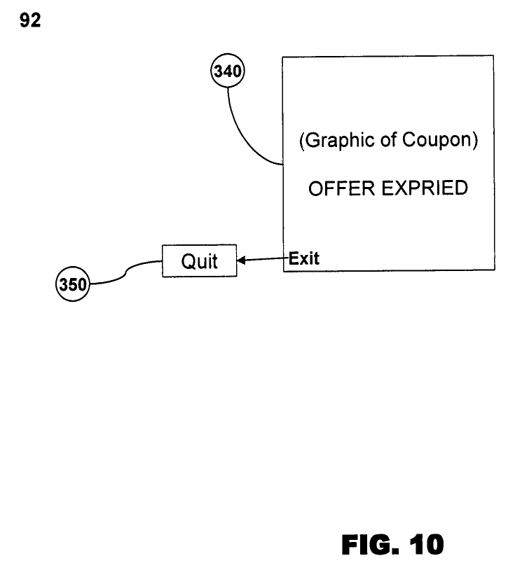

Step 130 addresses the circumstance of offer expiration. The user interface screen informs the consumer, step 140 of an expired offer, depicted generally in step 340 of the user interface 92 of FIG. 10. As further shown in FIG. 10, the consumer leaves the application, step 350.

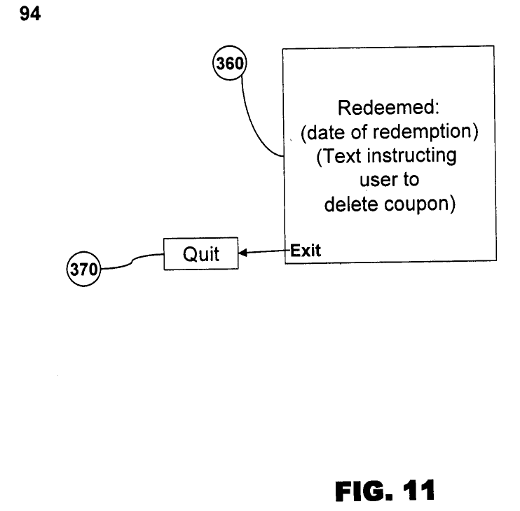

If the offer has been redeemed, step 150, the user interface screen informs the consumer, step 160 of redemption, depicted generally in step 360 of the user interface 94 of FIG. 11. As further shown in FIG. 11, the consumer leaves the application, step 370.

Valid coupon offers are displayed on the handset user interface screen, step 170, providing the consumer with the options of exiting, step 180, or redeeming the coupon, step 190. The valid coupon offer is depicted generally in step 260 of the user interface 80 of FIG. 8. As further shown in FIG. 8, the consumer is provided a link to a Java application descriptor file.

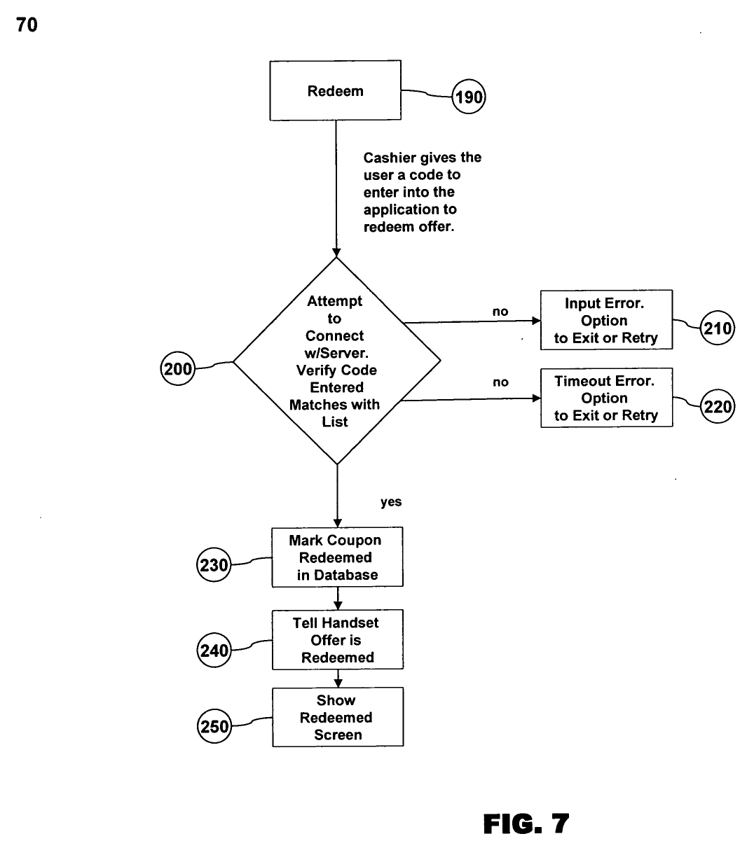

FIG. 7 illustrates the process 70 for redeeming a secure wireless coupon application supporting the embodiments of the present invention generally described above and illustrated in FIGS. 1-5. As depicted generally in FIG. 7, the customer clicks on a URL associated with a particular offer. A unique code for the particular customer is sent to the system server to validate. The system compiles a Java Archive (“JAR”) file comprising at least a time stamped application comprising at least one graphic. An associated Java Application Descriptor file is written. If the code is valid, the customer is offered the application for download.

At step 190, redemption by the consumer is initiated by a point-of-sale cashier providing a unique code to enter into the application to redeem the offer. While the method, system and software of the present invention do not require barcode graphics for redemption, an embodiment of the present invention can be used with barcode graphics if required at the point-of-sale.

The consumer's handset attempts to connect to the retailer's server, step 200, and the entered code is verified by matching with a list within the retailer database. If the entered code does not match, the consumer is given the options of retrying the code or exiting the application, step 210. If the code is not input within a preset time interval within the application, the consumer is given the options of retrying the code or exiting the application, step 220.

Entered codes matched within the redeeming retailer's database result in marking the application coupon as redeemed, step 230.

The redeemed coupon status is transmitted to the consumer's handset, step 240.

The user interface screen of the consumer handset displays the redemption, step 250, and as more particularly illustrated in step 360 of the user interface 94 of FIG. 11. As further shown in FIG. 11, the consumer leaves the application, step 370.

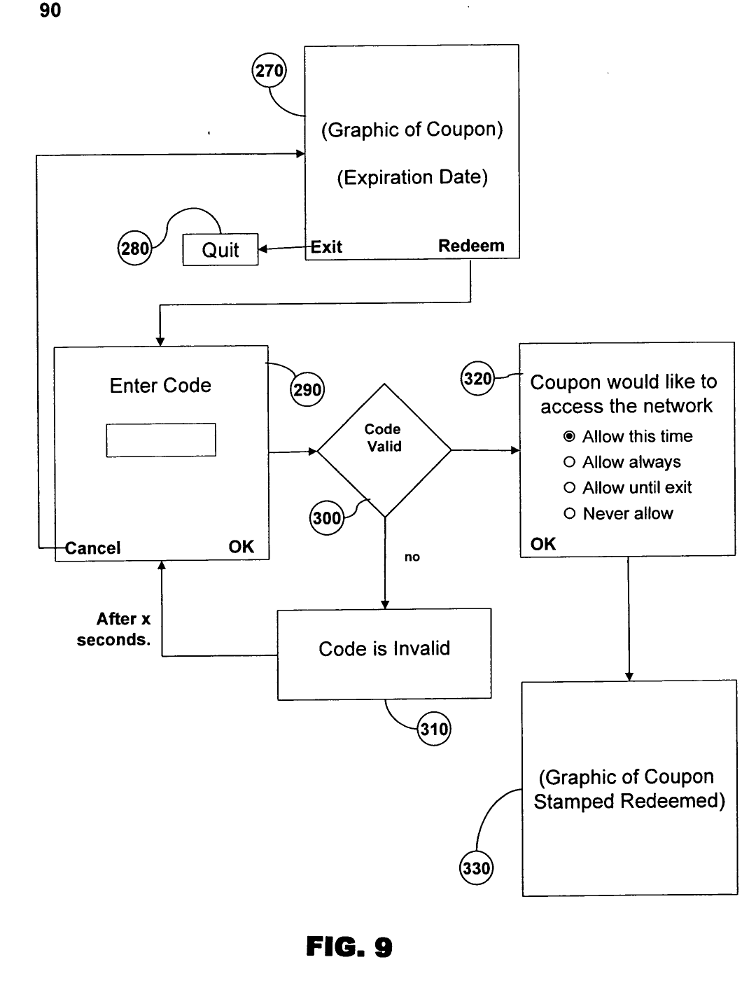

The coupon redemption process 90 of an embodiment of the present invention is more specifically illustrated in FIG. 9.

As depicted in FIG. 9, the customer either launches the coupon application, step 270, and presents the associated handset to the point-of-sale cashier for redemption or exits the system and the application ends, step 280. If the application is still time valid, the cashier enters a predetermined redemption sequence or code on the handset key pad and clicks “redeem,” step 290.

Valid codes, step 300, are routed to a mode predetermined in the UI of the mobile phone, step 320, wherein the coupon is allowed to access the network one, always, until the application exits, or never, depending upon the user's input. Successful access to the network upon redemption delivers a message on the screen of the user's mobile device that the coupon is set to redeemed, and text instructing the user to delete the coupon as more specifically illustrated by step 360 of the user interface 94 of FIG. 11. As further shown in FIG. 11, the consumer leaves the application, step 370.

Invalid code entry, step 310, redirects the user to the code entry step 290.

This redemption sequencing process prevents accidental redemption of the coupon. It also allows retailers with multiple locations to assign a unique redemption code for more granular tracking of a particular promotional offer. The application calls into the server and the coupon is marked as redeemed in the database. Once redeemed, the application is set to redeemed mode. If the redemption point-of-sale retailer is in an area without cellular reception, the application will attempt to call into the server the next time the application is launched. An application in redeemed mode prevents further access by the customer to the coupon graphic. When the application is launched, a thank you message screen is provided to the customer with instruction to delete the application, FIG. 11. If the application is not time valid once the customer launches the coupon application, a screen message will appear notifying the customer that the offer has expired and instructing the customer to delete the application, FIG. 10.

The J2ME coupon application of an embodiment of the present invention provides an easy to use image viewing applications that can run on any J2ME telephone with little or no handset specific modification. The J2ME coupon application of an embodiment of the present invention provides a viewer for graphic files that monitors the variables relating to the expiration of the offer. In this fashion, coupon sharing within Wireless Application Protocol (“WAP”) is prevented without using some fashion of Digital Rights Management (“DRM”). An embodiment of the present invention comprises an application that stays on the handset and is periodically refreshed with new offers. Another embodiment of the present invention could be combined with Binary Run-Time Environment for Wireless (“BREW”) or Wireless Application Protocol (“WAP”) using DRM.

Any of the embodiments of the present invention could provide a general coupon application, or coupon pack. Similarly, any of the embodiments of the present invention could serve coupons from a plurality of vendors. The embodiments of the present invention could be global positioning satellite aware to offer location-based coupons.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed the spirit and scope of the invention.

We claim:

1. A system for delivering secure supplemental content to an end user on a data communications network, comprising:
a data communications network;
at least one content server connected to the data communications network;
at least one end user electronic display device connected to the data communications network;
means for providing at least one content server supplemental content to at least one end user's electronic display device connected to the data communications network;
means to generate at least one interactive display from the content server to at least one end user electronic display device;
means to archive and identify at least one end user within the data communications network based upon end user response to at least one interactive display on the end user's electronic display device; and
means to redeem the supplemental content at a point-of-sale and delete the supplemental content from the end user's electronic display device.

2. The system of claim 1, wherein the data communications network is wireless.

3. The system of claim 1, where in the end user electronic display device accepts platform execution applications chosen from the group comprising: Java 2 Platform Micro Edition; Binary Run-Time Environment for Wireless; and Wireless Application Protocol using Digital Rights Management.

4. The system of claim 1, wherein the interaction to allow redemption the supplemental content at a point-of-sale comprises a redemption sequence input into the end user electronic display device.

5. The system of claim 1, wherein the interaction to allow redemption the supplemental content at a point-of-sale comprises bar-code scanning a content display on the end user electronic display device.

6. The system of claim 1, wherein the interactive display from the content server to the end user electronic display device contains a uniform resource locator to a Java 2 Platform Micro Edition application.

7. The system of claim 6, wherein the uniform resource locator is appended with a unique code.

8. The system of claim 7, wherein the code is recorded in a database.

9. The system of claim 8, wherein the code contains at least one security parameter of a group comprising: a Java application descriptor file; notification identifier; password; coupon identifier; and a Java archive file.

10. The system of claim 1, wherein means for providing at least one content server supplemental content to at least one end user's electronic display device connected to the data communications network, means to generate at least one interactive display from the content server to at least one end user electronic display device, means to archive and identify at least one end user within the data communications network based upon end user response to at least one interactive display on the end user's electronic display device, and means to redeem the supplemental content at a point-of-sale and delete the supplemental content from the end user's electronic display device further comprise at least computer program product

11. The system of claim 10, wherein the software applications are chosen from the group comprising: Java 2 Platform Micro Edition; Binary Run-Time Environment for Wireless; and Wireless Application Protocol using Digital Rights Management.

12. The system of claim 1, further comprising an interactive Internet site on the World Wide Web.

13. The system of claim 1, wherein the supplemental content is mobile coupons.

14. A method for delivering supplemental content to at least one end user on a data communications network and allowing the end user to present the content to a point-of-sale for redemption, the method comprising the steps of:
(a) selecting at least one supplemental content for presentation to at least one electronic display device associated with at least one end user over a data communications network;
(b) registering at least one end user's electronic display device with a data base;
(b) transmitting the supplemental content to at least one at least one electronic display device associated with a respective registered end user in the data base;
(c) receiving acceptance of the supplemental content from at least one end user;
(d) downloading at least one time sensitive software application to the end user, wherein each downloaded application is unique;
(e) activating each unique application at a point-of-sale;
(f) redeeming each activated application; and
(g) removing the supplemental content associated with the application from the user's electronic display device post redemption.

15. The method of claim 14, wherein the data communications network comprises wireless technology.

16. The method of claim 14, wherein the electronic display device accepts platform execution applications chosen from the group comprising: Java 2 Platform Micro Edition; Binary Run-Time Environment for Wireless; and Wireless Application Protocol using Digital Rights Management.

17. The method of claim 14, wherein the supplemental content comprises a uniform resource locator to an application chosen from the group comprising: Java 2 Platform Micro Edition; Binary Run-Time Environment for Wireless; and Wireless Application Protocol using Digital Rights Management.

18. The method of claim 14, wherein the acceptance of the supplemental content by an end user appends a unique code to the uniform resource locator which is recorded into the database.

19. The method of claim 14, wherein the time sensitive software application is based upon information in the database.

20. The method of claim 14, wherein the time sensitive software application directs an end user to a self-service website where a plurality of supplemental content may be considered by the end user and selectively downloaded by the end user from the database to the end user's electronic display device.

21. The method of claim 14, wherein activation further comprises entry of a unique redemption code into the end user's electronic display device.

22. The method of claim 21, wherein redemption further comprises the end user's electronic display device attempting to connect to the database until successful.

23. The method of claim 22, wherein redemption further comprises the application setting the supplemental content on the end user's electronic display device associated with the respective point-of-sale transaction to the redeemed mode.

24. The method of claim 22, wherein the supplemental content is rejected by a point-of-sale retailer if the end user's electronic display device fails to connect to the database.

25. The method of claim 14, wherein activation further comprises generation of a unique code that a point-of sale retailer can record to show the supplemental content has been redeemed.

26. The method of claim 25, comprising entry of the unique redemption code into the database by the point-of-sale retailer.

27. The method of claim 14, wherein the software application comprises at least one of the following: an application descriptor file; notification identifier; password; coupon identifier; and an archive file.

28. A computer program product for use in a system having at least one data communications network, at least one content server connected to the data communications network, and at least one end user electronic display device connected to the data communications network, wherein the network is a distributed hypermedia environment, the computer program comprising a computer usable medium having computer readable program code physically embodied therein, the computer program product code further comprising:
computer readable program code for causing the content server to supply supplemental content to at least one end user's electronic display device;
computer readable program code for generating at least one interactive display from the content server to at least one end user electronic display device;
computer readable program code for archiving and identifying at least one end user within the data communications network based upon end user response to at least one interactive display on the end user's electronic display device; and
computer readable program code for redeeming the supplemental content at a point-of-sale and deleting the supplemental content from the end user's electronic display device.

29. The computer program product of claim 28, wherein the data communications network is wireless.

30. The computer program product of claim 28, wherein the computer readable program code is chosen from the group of platform execution applications comprising: Java 2 Platform Micro Edition; Binary Run-Time Environment for Wireless; and Wireless Application Protocol using Digital Rights Management.

31. The computer readable program code of claim 28, wherein the computer readable program code to allow redemption the supplemental content at a point-of-sale comprises a redemption sequence input into the end user electronic display device.

32. The computer readable program code of claim 28, wherein the computer readable program code to allow redemption the supplemental content at a point-of-sale comprises bar-code scanning a content display on the end user electronic display device.

33. The computer readable program code of claim 28, wherein the interactive display from the content server to the end user electronic display device contains a uniform resource locator to an application chosen from the group of execution platforms comprising: Java 2 Platform Micro Edition; Binary Run-Time Environment for Wireless; and Wireless Application Protocol using Digital Rights Management.

34. The computer program product of claim of claim 33, wherein the uniform resource locator is appended with a unique code.

35. The computer program product of claim of claim 34, wherein the code is recorded in a database.

36. The computer program product of claim of claim 35, wherein the code contains at least one security parameter of a group comprising: an application descriptor file; notification identifier; password; coupon identifier; and an archive file.

37. The computer program product of claim 28, further comprising an interactive Internet site on the World Wide Web.

38. The computer program product of claim 28, wherein the supplemental content is mobile coupons.
